(19) United States
(12) Patent Application Publication
(10) Pub. No.: US 2012/0293774 A1
(43) Pub. Date: Nov. 22, 2012

(54) PROJECTOR LENS SYSTEM AND IMAGE DISPLAY SYSTEM USING SAME

(75) Inventors: Masahiro INOUE, Fukuoka (JP); Shinichi KADOWAKI, Fukuoka (JP)

(73) Assignee: PANASONIC CORPORATION, Osaka (JP)

(21) Appl. No.: 13/469,702

(22) Filed: May 11, 2012

(30) Foreign Application Priority Data
May 20, 2011 (JP) 2011-113164
Aug. 2, 2011 (JP) 2011-169438

(51) Int. Cl. G03B 21/14; G02B 13/04; G02B 13/22

(52) U.S. Cl. 353/31; 359/663

(57) ABSTRACT

In a projector lens system including at least three lens elements and telecentric on a side of an optical modulator, two of the lens elements located on outer most ends of the projector lens system facing conjugate points of the projector lens system consist of plastic lenses, and an aperture stop of the projector lens system is located between the two outer most lens elements while at least one of the lens elements other than the two outer most lens elements most adjacent to the aperture stop consists of a glass lens. Thereby, the cost and weight of the projector lens system can be reduced while achieving the required optical properties.

### TECHNICAL FIELD

1. Field of the Invention

The present invention relates to a projector lens system and an image display system suitable for use in small projectors.

2. Description of the Related Art

In recent years, there is a growing interest in the use of the semiconductor laser as the light source of image display systems. The semiconductor laser has various advantages over the mercury lamp which is commonly used as the light source for more conventional image display systems, such as a better color reproduction, the capability to turn on and off instantaneously, a longer service life, a higher efficiency (or a lower power consumption) and the amenability to compact design.

Such advantages are particularly beneficial when the image display system using a semiconductor laser is used in a portable electronic device such as a mobile phone (Patent Document 1: JP2007-316393A). The image display system incorporated in a portable electronic terminal can project an image on a screen in a highly enlarged scale as required, and it proves to be useful in many applications. Also, when the image display system is incorporated in a portable information processing device such as a laptop computer, the usefulness of the portable information processing device can be highly enhanced.

In recent years, there is a growing need for higher resolution, greater brightness and a longer focal length in such small projectors. Such a need can be met by developing projector lens systems that allow a compact design of the optical system. A known projector lens system includes a first negative meniscus lens element and a second biconvex lens element, arranged in that order from the light source, and the two lens elements are both provided with aspheric lens surfaces (Patent Document 2; JP2007-316393A).

However, the projector lens system disclosed in Patent Document 2 is unable to provide a high resolution, a high brightness and a long focal length that are required for the projector lens system to be used in a small projector owing to a limited number of lens elements. A high resolution, a high brightness and a long focal length can be achieved by increasing the number of lens elements, but it increases the length of the optical system, and prevents the compact design of the projector. Therefore, there is a need for a projector lens system which can achieve a high resolution, a high brightness and a long focal length without requiring a large number of lens elements.

A semiconductor laser used as a light source for a small projector typically includes individual semiconductor laser units for red, green and blue colors as is the case with the projector disclosed in Patent Document 1, and the projector lens system for such a projector is required to be able to withstand the high energy light beams emitted from the semiconductor laser units.

On the other hand, as the projector lens system disclosed in Patent Document 2 is made of plastic lens elements which are suited to be shaped into the required complex shapes as compared with the glass lens elements, the durability of the lens elements may be a problem. In particular, the blue laser light emitted from the blue laser unit causes more damage to the plastic lens than laser light of other colors, and the lens may lose the original transmittance over an extended period of time. The increase in the output of the laser unit to meet the need for an ever higher brightness compounds this problem.

### BRIEF SUMMARY OF THE INVENTION

In view of such problems of the prior art, a primary object of the present invention is to provide a projector lens system and an image display system that can achieve a high resolution, a high brightness and a long focal length in a small projector using a semiconductor laser as a light source which allowing a highly compact design.

To achieve such an object, the present invention provides projector lens system including at least three lens elements and telecentric on a side of an optical modulator, wherein: two of the lens elements located on outer most ends of the projector lens system facing conjugate points of the projector lens system consist of plastic lenses; an aperture stop of the projector lens system is located between the two outer most lens elements; and at least one of the lens elements other than the two outer most lens elements most adjacent to the aperture stop consists of a glass lens.

Another object of the present invention is to provide an image display system that can be constructed as a highly light weight unit.

To achieve such an object, the present invention provides an image display system, comprising: a blue light source emitting blue light; a green light source emitting green light; a red light source emitting red light; and an optical system including a plurality of lens elements and receiving the light of the various colors; wherein at least one of the lens elements that receives the blue light with an optical power density of 180 mW/mm² or less is made of plastic material while at least one of the lens elements that receives the blue light with an optical power density of more than 180 mW/mm² is made of glass.

### BRIEF DESCRIPTION OF THE DRAWINGS

Now the present invention is described in the following with reference to the appended drawings, in which:

FIG. 1 is a perspective view of a laptop information processing apparatus incorporated with an image display system embodying the present invention;

FIG. 2 is a schematic diagram illustrating an optical engine unit of the image display system;

FIG. 3 is a diagram showing how a green laser beam is generated by a green laser light source unit of the image display system;

FIG. 4 is a diagram showing the arrangement of lens elements in a projector lens system according to the present invention;

FIG. 5 is a table showing the specifications of the lens elements in the projector lens system shown in FIG. 4;

FIG. 6 is a diagram explaining the image height and the object height;

FIG. 7 is a graph showing the spherical aberration;

FIG. 8 is a graph showing the astigmatism;

FIG. 9 is a graph showing the distortion;

FIG. 10 is a graph showing the chromatic aberration;

FIGS. 11a to 11d are graphs showing the lateral coma aberration for each of the points P1, P2, P3 and P4 of FIG. 4, respectively;

FIG. 12 is a diagram showing the arrangement of lens elements in a projector lens system given as a second embodiment of the present invention;

FIG. 13 is a table showing the specifications of the lens elements in the projector lens system of the second embodiment shown in FIG. 12;

FIG. 14 is a graph showing the spherical aberration of the second embodiment;

FIG. 15 is a graph showing the astigmatism of the second embodiment;

FIG. 16 is a graph showing the distortion of the second embodiment;

FIG. 17 is a graph showing the chromatic aberration of the second embodiment;

FIGS. 18a to 18d are graphs showing the lateral coma aberration of the second embodiment for each of the points P1, P2, P3 and P4 of FIG. 4, respectively;

FIG. 19 is a diagram showing the arrangement of lens elements in a projector lens system given as a third embodiment of the present invention;

FIG. 20 is a table showing the specifications of the lens elements in the projector lens system of the third embodiment shown in FIG. 19;

FIG. 21 is a graph showing the spherical aberration of the third embodiment;

FIG. 22 is a graph showing the astigmatism of the third embodiment;

FIG. 23 is a graph showing the distortion of the third embodiment;

FIG. 24 is a graph showing the chromatic aberration of the third embodiment;

FIGS. 25a to 25d are graphs showing the lateral coma aberration of the third embodiment for each of the points P1, P2, P3 and P4 of FIG. 4, respectively;

FIG. 26 is a schematic diagram illustrating an optical engine unit of the image display system;

FIG. 27 is a graph showing the changes in the transmittance of the lens when light having various wavelengths is radiated on the lens for 1,000 hours;

FIG. 28 is a graph showing the changes in the transmittance of the lens when light of various optical power densities is radiated on the lens;

FIG. 29 is a graph showing the changes in the transmittance of the lens over time when blue light is radiated on the lens in dependence on the materials for the lens;

FIG. 30 is a diagram showing the lens layout of the optical system of the image display system;

FIGS. 31a is a schematic diagram of the lens layout of the projector lens system when the lenses are strictly made of glass; and

FIG. 31b is a similar view when a part of the lenses are made of plastic material.

### DETAILED DESCRIPTION OF THE PREFERRED EMBODIMENT(S)

An embodiment of the present invention is described in the following with reference to the appended drawings.

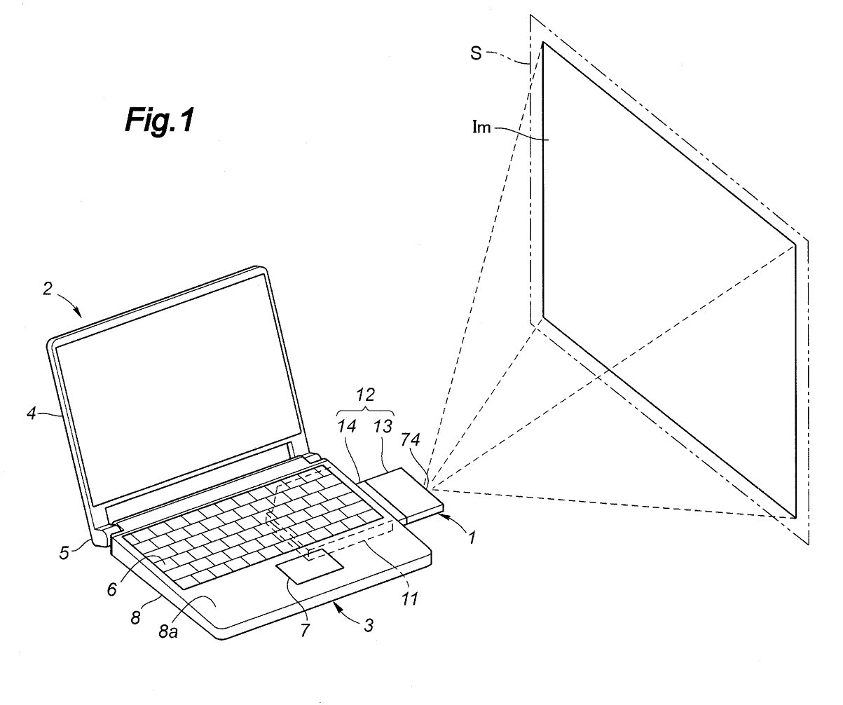

FIG. 1 is a perspective view of an information processing apparatus 2 incorporated with an image display system 1 embodying the present invention. The information processing apparatus 2 of the illustrated embodiment is constructed as a laptop computer including a main body 3 incorporated with a control circuit board (not shown in the drawing) including a CPU, memory and other components, and a display unit 4 hinged to the main body 3 and incorporated with an LCD panel. The display unit 4 may be folded onto the main body 3 for an improved portability.

The upper surface 8a of a casing 8 of the main body 3 is provided with a keyboard 6 and a touch pad 7. The main body 3 internally defines a storage space or a drive bay inside the casing 8 behind the keyboard 4 for removeably receiving a peripheral device such as an optical drive, and an image display system 1 may be fitted in this drive bay.

The image display system 1 includes a system housing 11 and a moveable part 12 slidably or retractably connected to the system housing 11. The moveable part 12 includes an optical engine unit (first unit) 13 receiving various optical components for projecting an image Im created by laser light onto a screen S therein and a control unit (second unit) 14 receiving a circuit board and associated electric components for controlling the optical engine unit 13 therein.

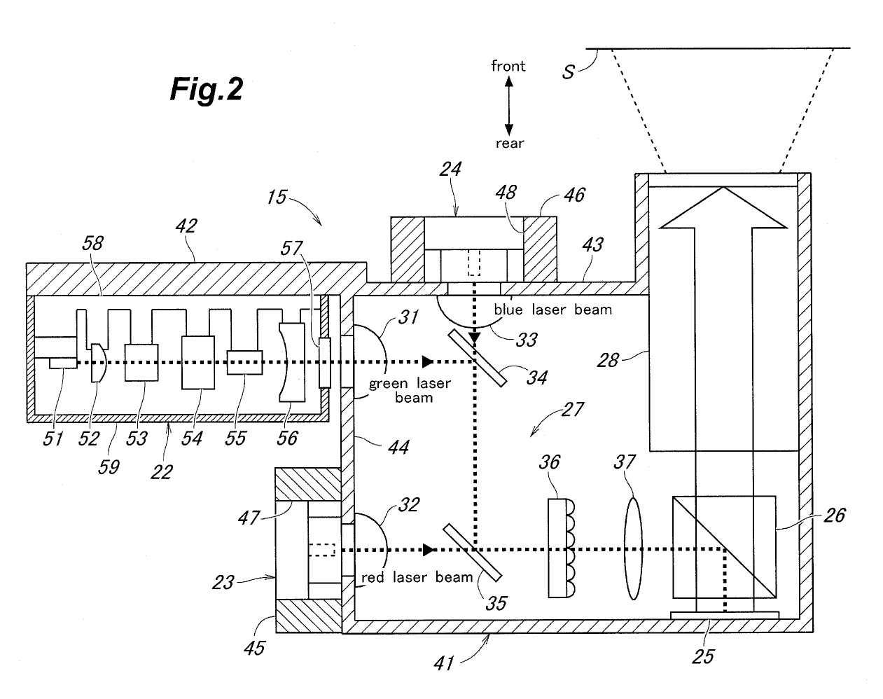

FIG. 2 is a schematic diagram illustrating an optical engine 15 of the optical engine unit 13 of the image display system 1. The optical engine 15 comprises a green laser light source unit 22 for emitting a green laser beam, a red laser light source unit 23 for emitting a red laser beam, a blue laser light source unit 24 for emitting a blue laser beam, a spatial light modulator 25 of a reflective LCD type for forming the required image by spatially modulating the laser beams from the green, red and blue laser light source units 22 to 24 according to the given video signal, a polarizing beam splitter 26 that reflects the laser beams emitted from the green, red and blue laser light source units 22 to 24 onto the spatial light modulator 25 and transmits the modulated laser beam emitted from the spatial light modulator 25, a relay optical system 27 for directing the laser beams emitted from the green, red and blue laser light source units 22 to 24 to the beam splitter 26, and a projector lens system (projection optical system) 28 for projecting the image created by the modulated laser beam and transmitted through the beam splitter 26 onto the screen S. The laser light source units 22 to 24 may use semiconductor lasers as light sources.

The optical engine 15 is configured to display a color image on the screen S by using the field sequential process (time sharing display process), and the laser beams of different colors are emitted from the corresponding laser light source units 22 to 24 sequentially in a time sharing manner so that the laser beams of the different colors emitted intermittently and projected onto the screen are perceived as a unified color afterimage.

The relay optical system 27 comprises collimator lenses 31 to 33 for converting the laser beams of different colors emitted from the corresponding laser light source units 22 to 24 into parallel beams of the different colors, first and second dichroic mirrors 34 and 35 for directing laser beams of the different colors exiting the collimator lenses 31 to 33 in a prescribed direction, a diffusion plate 36 for diffusing the laser beams guided by the dichroic mirrors 34 and 35 and a field lens 37 for converting the laser beam transmitted through the diffusion plate 36 into a converging laser beam.

If the side of the projector lens system 28 from which the laser beam is emitted to the screen S is defined as the front side, the blue laser light source unit 24 emits the blue laser beam in the rearward direction. The green and red laser light source units 22 and 23 emit the green laser beam and red laser beam, respectively, in a direction perpendicular to the blue laser beam. The blue, red and green laser beams are conducted to a common light path by the two dichroic mirrors 34 and 35. More specifically, the blue laser beam and green laser beam are conducted to a common light path by the first dichroic mirror 3, and the blue laser beam, red laser beam and green laser beam are conducted to a common light path by the second dichroic mirror 3.

The surface of each dichroic mirror 34, 35 is coated with a film that selectively transmits light of a prescribed wavelength while reflecting light of other wavelengths. The first dichroic mirror 34 transmits the blue laser beam while reflecting the green laser beam, and the second dichroic mirror 35 transmits the red laser beam while reflecting the blue and green laser beams.

These optical components are received in a housing 41 which is made of thermally conductive material such as aluminum and copper so as to serve as a heat sink for dissipating the heat generated from the laser light source units 22 to 24.

The green laser light source unit 22 is mounted on a mounting plate 42 secured to the housing 41 and extending laterally from the housing 41. The mounting plate 42 extends from the corner between a front wall 43 and a side wall 44 of the housing 41 in a direction perpendicular to the side wall 44. The red laser light source unit 23 is retained in a holder 45 which is in turn attached to the outer surface of the side wall 44, and the blue laser light source unit 24 is retained in a holder 46 which is in turn attached to the outer surface of the front wall 43.

The red and blue laser light source units 23 and 24 are each prepared in a CAN package in which a laser chip supported by a stem is placed on the central axial line of a can so as to emit a laser beam in alignment with the central axial line of the can and out of a glass window provided on the can. The red and blue laser light source units 23 and 24 are secured to the respective holders 45 and 46 by being press fitted into mounting holes 47 and 48 formed in the corresponding holders 45 and 46. The heat generated in the laser chips of the red and blue laser light source units 23 and 24 is transmitted to the housing 41 via the holders 45 and 46, and is dissipated to the surrounding environment from the housing 41. The holders 45 and 46 may be made of thermally conductive material such as aluminum and copper.

As shown in FIG. 2, the green laser light source unit 22 comprises a semiconductor laser 51 for producing an excitation laser beam, a FAC (fast axis collimator) lens 52 and a rod lens 53 for collimating the excitation laser beam produced from the semiconductor lens 51, a laser medium 54 for producing a base wavelength laser beam (infrared laser beam) through excitation by the excitation laser beam, a wavelength converting device 55 for producing a half wavelength laser beam (green laser beam) by converting the wavelength of the base wavelength laser beam, a concave mirror 56 for forming a resonator in cooperation with the laser medium 54, a glass cover 57 for preventing the leakage of the excitation laser beam and base wavelength laser beam, a base 58 for supporting the various component parts and a cover member 59 covering the various components.

The base 58 of the green laser light source unit 22 is fixedly attached to the mounting plate 42 of the housing 41 such that a gap of a prescribed width (such as 0.5 mm or less) is formed between the green laser light source unit 22 and the side wall 44 of the housing 41. Thereby, the heat generated from the green laser light source unit 22 is insulated from the red laser light source unit 23 so that the red laser light source unit 23 having a relatively low tolerable temperature is prevented from heat, and is enabled to operate in a stable manner. To obtain a required adjustment margin (such as about 0.3 mm) for the optical center line of the red laser light source unit 23, a certain gap (such as 0.3 mm or more) is provided between the green laser light source unit 22 and the red laser light source unit 23.

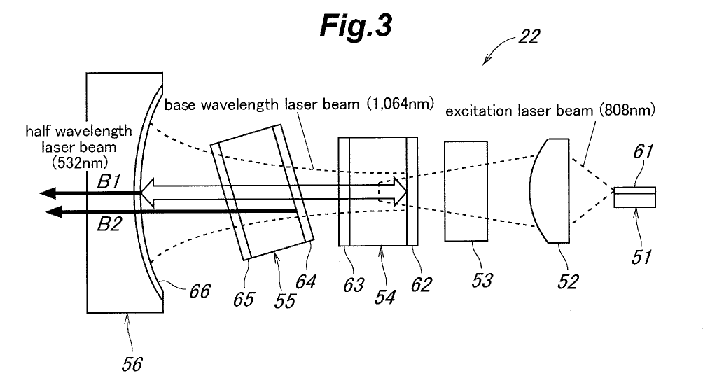

FIG. 3 is a diagram showing how the green laser beam is generated by the green laser light source unit 22 of the image display system 1. The semiconductor laser 51 comprises a laser chip 61 that produces an excitation laser beam having a wavelength of 808 nm. The FAC lens 52 reduces the expansion of the laser beam in the direction of the fast axis of the laser beam (which is perpendicular to the optical axial line and in parallel with the plane of the paper of the drawing), and the rod lens 53 reduces the expansion of the laser beam in the direction of the slow axis of the laser beam (which is perpendicular to the plane of the paper of the drawing).

The laser medium 54 consists of a solid laser crystal that produces a base wavelength laser beam (infrared laser beam) having a wavelength of 1,064 nm by the excitation caused by the excitation laser beam having the wavelength of 808 nm. The laser medium 54 may be prepared by doping inorganic optically active substance (crystal) consisting of Y (yttrium) and VO₄ (vanadate) with Nd (neodymium). In particular, yttrium in YVO₄ is substituted by Nd⁺³ which is fluorescent.

The side of the laser medium 54 facing the rod lens 53 is coated with a film 62 designed to prevent the reflection of the excitation laser beam having the wavelength of 808 nm, and fully reflect the base wavelength laser beam having the wavelength of 1,064 nm and the half wavelength laser beam having the wavelength of 532 nm. The side of the laser medium 54 facing the wavelength converting device 55 is coated with a film 63 designed to prevent the reflection of both the base wavelength laser beam having the wavelength of 1,064 nm and the half wavelength laser beam having the wavelength of 532 nm

The wavelength converting device 55 consists of a SHG (Second Harmonics Generation) device that is configured to convert the base wavelength laser beam (infrared laser beam) having the wavelength of 1,064 nm generated by the laser medium 54 into the half wavelength laser beam having the wavelength of 532 nm (green laser beam).

The side of the wavelength converting device 55 facing the laser medium 54 is coated with a film 64 that prevents the reflection of the base wavelength laser beam having the wavelength of 1,064 nm, and fully reflects the half wavelength laser beam having the wavelength of 532 nm The side of the wavelength converting device 55 facing the concave minor 56 is coated with a film 65 that prevents the reflection of both the base wavelength laser beam having the wavelength of 1,064 nm and the half wavelength laser beam having the wavelength of 532 nm.

The concave mirror 56 is provided with a concave surface that faces the wavelength converting device 55, and the concave surface is coated with a film 66 that fully reflects the base wavelength laser beam having the wavelength of 1,064 nm, and prevents the reflection of the half wavelength laser beam having the wavelength of 532 nm. Thereby, the base wavelength laser beam having the wavelength of 1,064 nm is amplified by resonance between the film 62 of the laser medium 54 and the film 66 of the concave mirror 56.

The wavelength converting device 55 converts a part of the base wavelength laser beam having the wavelength of 1,064 nm received from the laser medium 54 into the half wavelength laser beam having the wavelength of 532 nm, and the remaining part of the base wavelength laser beam having the wavelength of 1,064 nm that has transmitted through the wavelength converting device 55 without being converted is reflected by the concave mirror 56, and re-enters the wavelength converting device 55 to be converted into the half wavelength laser beam having the wavelength of 532 nm. The half wavelength laser beam having the wavelength of 532 nm is reflected by the film 64 of the wavelength converting device 55, and exits the wavelength converting device 55.

If the laser beam B1 that enters the wavelength converting device 55 from the laser medium 54, and exits the wavelength converting device 55 after being converted of the wavelength thereof interferes with the laser beam B2 that is reflected by the concave mirror 56, and exits the wavelength converting device 55 after being reflected by the film 64, the laser output may be reduced.

To avoid this problem, the wavelength converting device 55 is tilted with respect to the optical axial line so that the laser beams B1 and B2 are prevented from interfering with each other owing to the refraction of the laser beams B1 and B2, and the reduction in the laser output can be avoided.

The glass cover 57 shown in FIG. 2 is formed with a film that prevents the leakage of the base wavelength laser beam having the wavelength of 1,064 nm and the half wavelength laser beam having the wavelength of 532 nm to the outside.

The housings of the optical engine unit 13 and the control unit 14 forming the moveable part are shaped as low profile rectangular boxes. The two sides of each of the housings for the optical engine unit 13 and the control unit 14 are provided with respective sliders (not shown in the drawings) that are configured to slide over guide rails (not shown in the drawings) provided in the system housing 11 so that the moveable part 12 may be pushed into and pulled out from the system housing 11 as required by the user. The end of the optical engine unit 13 remote from the hinge (or the control unit 14) is provided with a projecting window 74, and the light projected from the projector lens system 28 (FIG. 2) is emitted from this projecting window 74.

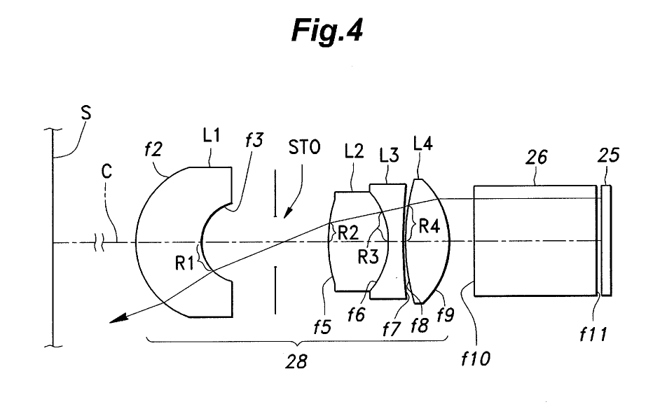

The specific arrangement of various lens elements in the first embodiment of the projector lens system 28 according to the present invention is described in the following with reference to FIG. 4. The various components are shown in section, but are not hatched for the clarity of illustration. The modulated projected light emitted from the polarizing beam splitter 26 on the right hand side of FIG. 4 is projected onto the screen S shown on the left hand side of FIG. 4 via the projector lens system 28.

The projector lens system 28 includes a first lens element L1, a second lens element L2, a third lens element L3 and a fourth lens element L4, in that order from the first conjugate focal point on the projecting side (left side of FIG. 4), in a coaxial relationship. The first and fourth lens elements L1 and L4 are plastic lenses made of plastic material while the second and third lens elements L2 and L3 are glass lenses made of glass material. The projector lens system 28 is placed coaxially on the optical axis of the modulated light beam from the optical modulator 25 in the illustrated embodiment, but the direction of the modulated light beam from the optical modulator 25 may be changed by using a reflector before entering the projector lens system 28 such that the optical modulator 25 is located laterally offset from the optical axis of the projector lens system 28. In the latter case, the projector lens system will be located on the optical axial line of the modulated light beam after being reflected by the reflector.

The first lens element L1 is formed as a quasi concave meniscus lens with a negative optical power (refractive power) having a centrally protruding side facing the projecting side. The second lens element L2 is formed as a biconvex spherical lens. The third lens element L3 is formed as a biconcave spherical lens. The fourth lens element L4 is formed as a quasi biconvex lens with a positive optical power.

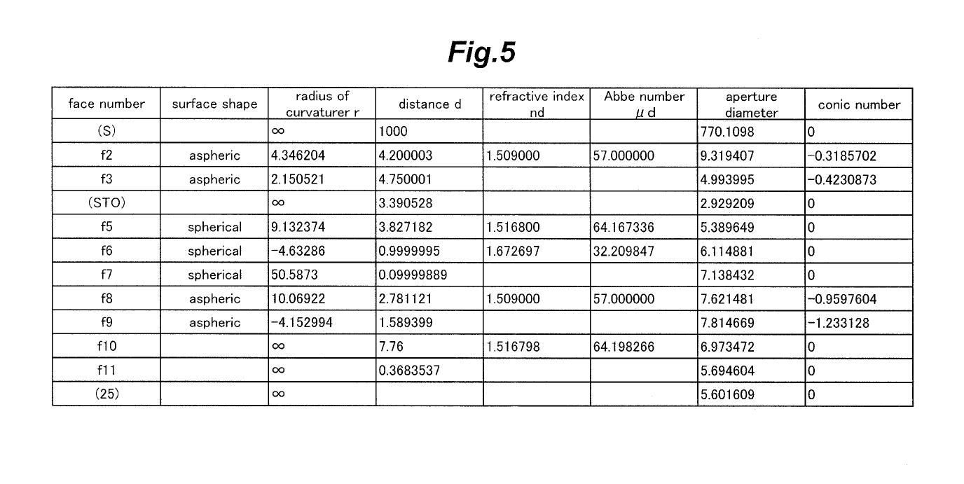

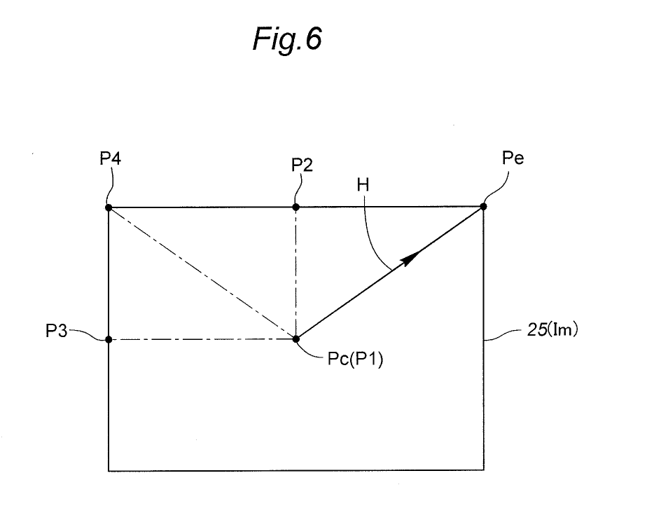

Table 1 shown in FIG. 5 lists the specifications of these lens elements used in the arrangement illustrated in FIG. 4. The parameters assumed for the lens data in Table 1 include a F value of 2.8, a focal distance of 7.3 mm, an image height of 2.794 mm at the optical modulator 25, a projected object image (Im) height of 385.064 mm at the screen S and a distance of 1,000 mm between the center of the lens surface of the first lens element facing the screen S and the screen S. The image height at the optical modulator 25 is defined as the height H of the image on the diagonal line drawn from the center Pc of the rectangular projecting surface of the optical modulator 25 and a corner point Pe thereof as shown in FIG. 6. The figure given above is the maximum value thereof The object image height at the screen S is similarly defined as the height H of the image on the diagonal line drawn from the center Pc of the rectangular projecting surface (Im) of the screen S and a corner point Pe thereof as shown in FIG. 6. The figure given above is the maximum value thereof The laser light of the different colors is weighted by one for the blue and red laser light and by two for the green laser light.

The surface numbers f2 to f11 given in Table 1 correspond to those shown in FIG. 4, and are numbered in ascending order from the projecting side, f1 corresponding to the screen S and f12 to the optical modulator 25. STO denotes an aperture stop which is located at a point where the main beam converges. The table further specifies if the lens element is spherical or aspheric, the radius of curvature (r) of the optical surface, the distance (d) on the optical axial line between the current optical surface (f(n)) and the succeeding optical surface (f(n+1)) where n is 1, . . . , 10, the refractive index (nd) for d-ray (light having a wavelength of 587.6 nm), the Abbe number (μd) for d-ray, the aperture diameter (D) and the conic constant (Co) of the aspheric lens. The unit for dimensions are “mm” unless otherwise specified.

The aspheric data of the aspheric lens elements are given in the following. The aspheric coefficients (Cen) of the fourth, sixth, eighth, tenth and twelfth orders are given by CE4, CE6, CE8, CE10 and CE12, respectively.
At surface number f2:
   CE4=−0.00019292138
   CE6=1.7519259e-5
   CE8=−2.633344e-7
   CE10=−2.8972131e-8
   CE12=1.0282375e-9
At surface number f3:
   CE4=0.00048703321
   CE6=−0.00021337964
   CE8=9.3720993e-6
   CE10=2.0665982e-6
   CE12=−3.532074e-7
At surface number f8:
   CE4=−0.0014457748
   CE6=5.699218e-5
   CE8=−9.9412743e-7
   CE10=−4.3846295e-8
   CE12=2.2483199e-9
At surface number f9:
   CE4=−6.1165958e-5
   CE6=7.5395918e-6
   CE8=−6.155347e-8
   CE10=−6.908151e-9
   CE12=6.0456066e-10

As shown in FIG. 4, the area of a circle having a radius given by the distance R1-R4 between the part of the main beam that travels on the optical axial line C and the part of the main beam defining a maximum divergent angle for each of the optical surfaces is defined as a projection area. When laser light with a power W1 is projected, the energy density E1-E4 at each of the lenses L1- L4 will be given by En=W1/(π×Rn×Rn).

In the first embodiment, the values of R1-R4 are such that R4>R1>R3>R2. Therefore, the highest energy density occurs at the second lens element L2. As mentioned above, the second lens element L2 consists of a glass lens, and is therefore relatively resistant to high energy densities so that the overall optical system acquires a relatively high resistance to high energy densities.

There is a growing need for projectors capable of displaying ever brighter images, and the resulting increase in the output power of the light source causes a high energy density in the optical system. The aperture stop STO causes a high energy density (optical power density) to be produced adjacent thereto by narrowing the light beam. Furthermore, the aperture stop STO is located at a conjugate point of the projector optical system with respect to the light source, and the laser light from the laser light source units 22-24 converges at a point adjacent to the aperture stop STO.

In the case of the blue laser light, the far field pattern is represented by a Gauss distribution so that the energy density at the center of the aperture stop STO or at the main beam of the projector lens system is maximized. In this case, if a plastic lens is placed near the aperture stop STO, the energy density at the center of the lens is so great that the optical degradation of the plastic material of the lens may be accelerated. Once the transmittance of the lens is reduced beyond a certain limit owing to the optical degradation of the lens caused by the yellowing or scorching of the plastic material, the lens ceases to function properly.

On the other hand, in the lenses which are remote from the aperture stop STO is subjected to a relatively diverged light beam, the laser light is spread over a large area so that the energy density is relatively small. According to the present invention, the first and fourth lens elements L1 and L4 that consist of plastic lenses are placed at such positions, and the degradation of the plastic material of the first and fourth lens elements L1 and L4 can be minimized. The light sources are not limited to semiconductor lasers, but may also consist of any other light sources, such as LEDs (light emitting diodes) and OLEDs (organic LEDs) that can illuminate the optical modulator.

In regard to a lens that requires to transmit the blue laser light which is particularly prone to degrading plastic material, only a limited range of plastic materials can be used as the material for the lens. However, a lens made of such a material limits the possible combinations of the refractive index and the Abbe number (dispersion), and is therefore unsuitable to be formed as an achromatic lens that can reduce the chromatic aberration. Furthermore, there may be a need to increase the power of the light sources even further.

An achromatic lens can be made more conveniently by using glass material. As an achromatic lens made of glass is free from optical degradation, the lens may be placed at a point (with a high energy density) adjacent to the aperture stop STO of the projecting lens 28 without any problem. According to the present invention, the third lens element L3 consisting of a glass lens is placed at a position adjacent to the aperture stop STO and forms an achromatic lens in cooperation with the fourth lens element L4 which is made of plastic material (but may also be made of glass).

The various optical aberrations of the projector lens system 28 given as the first embodiment are discussed in the following.

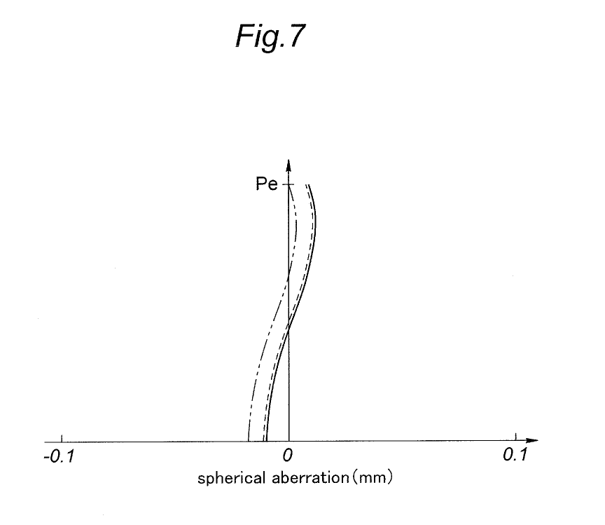

FIG. 7 shows the spherical aberration. In the graph of FIG. 7, the vertical axis represents the image height H and the lateral axis represents the magnitude of the spherical aberration, “zero” representing the absence of spherical aberration. The solid line represents the blue laser light, the double-dot chain-dot line represents the green laser light and the broken line represents the red laser light. The same notations may be used in the similar graphs in the following descriptions without repeating the explanation given here. In FIG. 7, the spherical aberration is given as a mathematical function of the image height for the laser light of each wavelength.

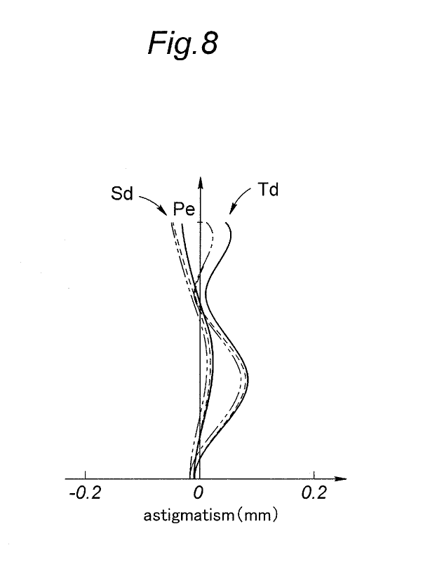

FIG. 8 shows the field curvature and the astigmatism. The curves on the left hand side of the graph represent the sagittal data (Sd) and the curves on the right hand side of the graph represent the tangential data (Td), and S-T gives the astigmatism. In this graph, the distance between the image plane and the near axis image plane is represented as a mathematical function of the field of view coordinates.

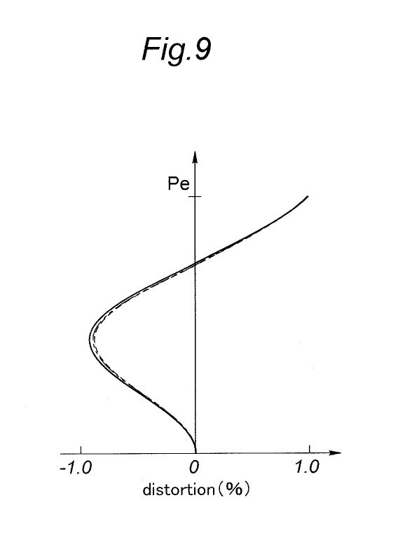

FIG. 9 shows the distortion. The magnitude of the distortion Dy is given by percentile figures on the lateral axis of the graph of FIG. 9. The following relationship holds:

Dy=100×(Yc−Yr)/Yr

where Dy is the magnitude of the distortion, Yc the actual height of the main beam, and Yr the reference height of the main beam.

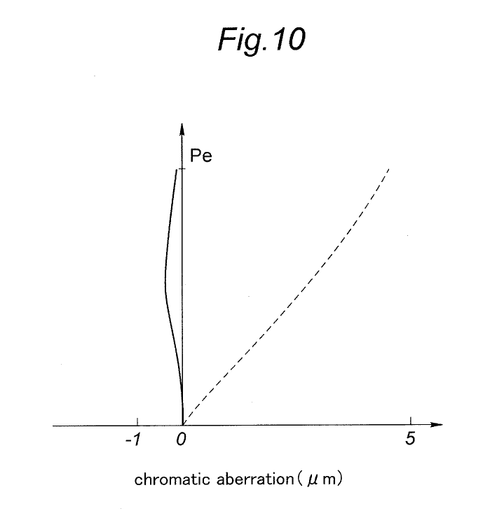

FIG. 10 shows the axial chromatic aberration. In the graph of FIG. 10, the axial chromatic aberration is given as a mathematical function of the field coordinates, and the axial chromatic aberrations of the blue and red laser light are shown, with the axial chromatic aberration of the green laser light given as a reference (with the axial chromatic aberration of the green laser light assumed as being zero).

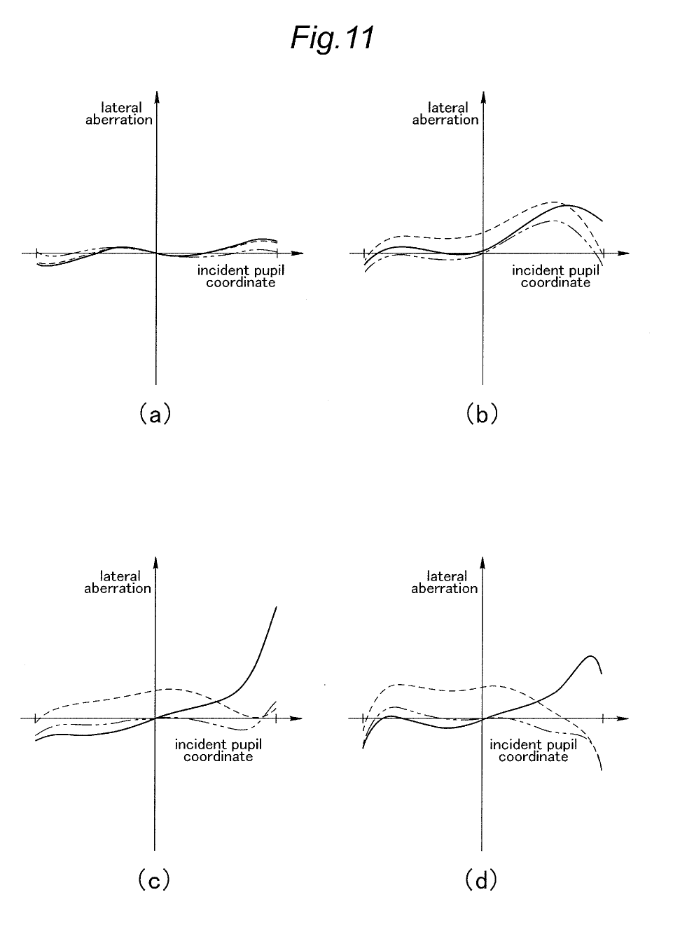

FIG. 11 shows the lateral coma aberration. In the graph shown in FIG. 11, the center represents the main beam, the lateral axis the pupil coordinate (±20μ at the maximum), and the vertical axis the value of the lateral aberration in each incident pupil coordinate. The lateral aberration is given as a mathematical function of the pupil coordinates. FIGS. 11a, 11b, 11c and 11d show the lateral aberrations in various points in FIG. 6, P1 (center), P2 (the upper most point of the image on the vertical line passing through the center), P3 (the upper most point of the image on the lateral line passing through the center) and P4 (one of the corner points). More specifically, with P1 given by 0 mm, the corresponding image heights are given by P2=1.44 mm, P3=2.4 mm and P4=2.794 mm.

The projector lens system 28 constructed as discussed above demonstrates highly controlled optical aberrations as shown in FIGS. 7 to 11, and can be favorably applied to small projectors.

The number of lens elements in the projector lens system 28 can be minimized by using strictly plastic lenses, but plastic lenses are disadvantageous in offering little freedom in the choice of the refractive index and the Abbe number as discussed above. Also, the generally available plastic materials for plastic lenses are not able to withstand the blue laser light, and the durable plastic materials are unacceptably costly. Therefore, it is not practical to use strictly plastic lenses in constructing small projectors that provide adequately high resolutions, high brightnesses and long focal lengths. As the focal length is extended, the chromatic aberration becomes more significant, and a relatively large number of lenses are required to adequately reduce the chromatic aberration.

On the other hand, in the illustrated embodiment of the present invention, the first and fourth lens elements L1 and L4 on the outer ends of the projector lens system 28 are formed by plastic lenses and the second and third lens elements L2 and L3 in the middle are formed by glass lenses. By thus strategically using the plastic lenses, the projector lens system 28 demonstrating favorable properties can be achieved with a minimum number of lens elements (L1 to L4) in an economical manner.

In particular, the second and third elements L2 and L3 consisting of glass lenses are formed into a single composite lens with the faces thereof (f6) having mutually complementary curvatures joined closely to each other, and a positive optical (refractive) power is achieved as a whole. Thereby, the aperture stop STO that is located between the first and second lens elements L1 and L2 can be positioned close to the second element L2 so that the energy density at the first lens element L1 consisting of a plastic lens can be minimized.

The problem of the plastic lens in offering a limited freedom in the choice of the refractive index and the Abbe number can be addressed by using glass lenses for the second and third lens elements L2 and L3. The Abbe number of the second lens element L2 near the aperture stop STO is greater than the Abbe number of the third lens element L3 remote from the aperture stop STO so that the chromatic aberration can be favorably reduced by combining lenses of different Abbe numbers in addition to the advantage of positioning the aperture stop STO close to the second lens element L2.

The first and fourth lens elements L1 and L4 consisting of plastic lenses can be freely configured. For instance, the first lens element L1 on the projecting side can be formed as an aspheric lens so that a large field of view may be achieved, and the fourth lens element L4 on the outer most end may also be formed as an aspheric lens which is telecentric and demonstrates a long back focal length. In this manner, the projector lens system 28 can be formed with a minimum number of lens elements L1 to L4.

Owing to this simple structure, the optical engine unit 13 incorporated with the projector lens system 28 of the illustrated embodiment can be small enough (less than 6.9 mm) to be accommodated in the housing of a laptop computer 2. The drive bay for a laptop computer is typically 9.5 mm thick, and the optical engine unit 13 having the thickness of less than 6.9 mm can be easily received in the drive bay. By using plastic aspheric lenses for the first and fourth lens elements L1 and L4, the length of the optical axial line can be reduced while using a minimum number of lenses, and the projector lens system 28 can be favorably used with an optical modulator 25 of a 0.22 inch size. The total optical length measured from the face of the first lens element L1 facing the first conjugate point (projecting side) to the optical modulator 25 can be reduced to 40 mm or less, and this allows the optical engine unit 13 to be safely received within the housing of the laptop computer 2.

The plastic material for the first and fourth lens elements L1 and L4 may consist of a cyclo-olefin polymer or a cyclo-olefin copolymer so that the capability of the first and fourth lens elements L1 and L4 to withstand optical radiation (in particular blue lase light) may be improved even further.

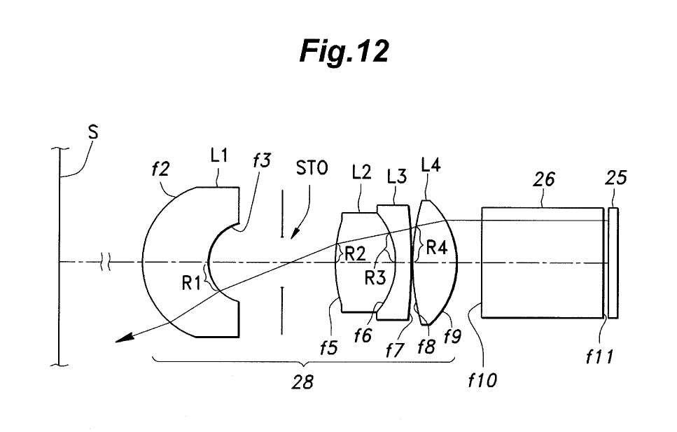

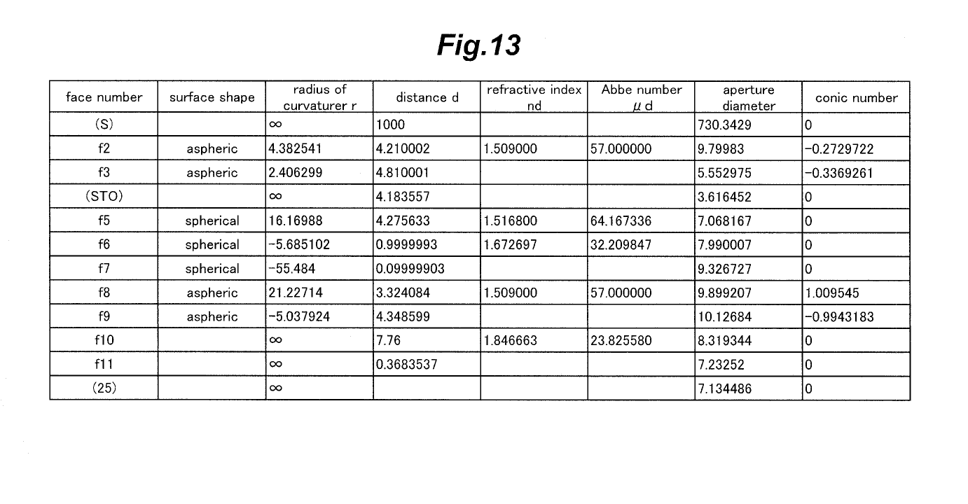

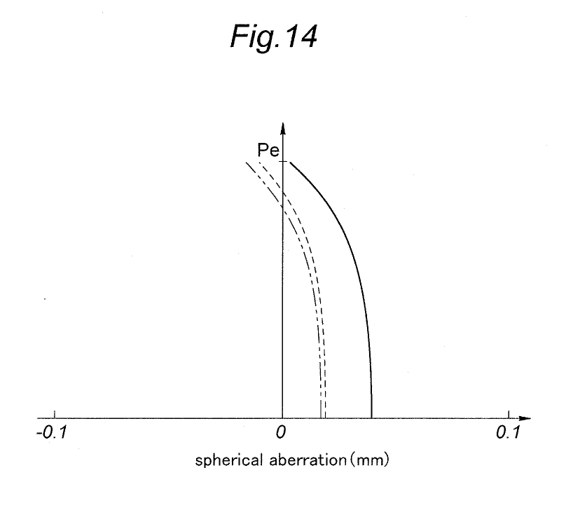

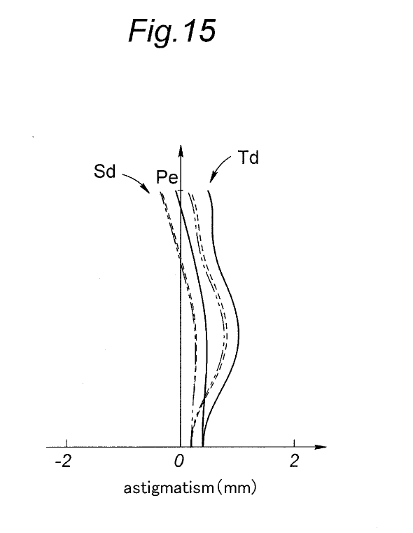

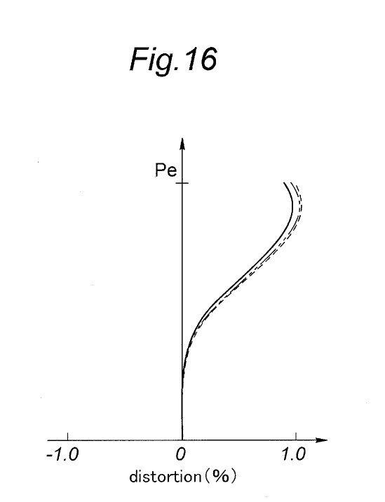

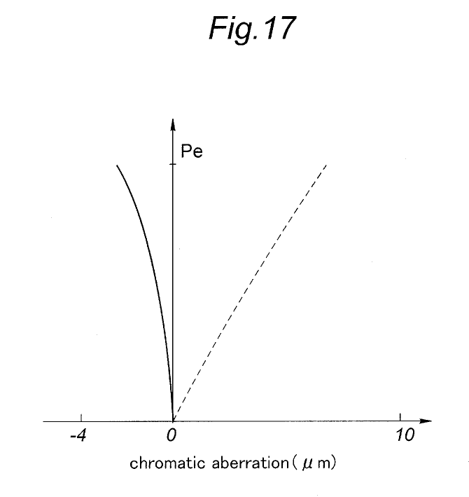

The lens data for the various lens components in the projector lens system 28 is not limited to those of the foregoing embodiment. A second embodiment of the present invention is described in the following with reference to FIGS. 12 to 18. FIGS. 12 and 13 correspond to FIGS. 4 and 5, respectively, and FIGS. 14 to 18 correspond to FIGS. 7 to 11. In these drawings, the parts corresponding to those of the first embodiment are denoted with like numerals.

As shown in FIG. 12, in the second embodiment, the lens surface f7 of the third lens element L3 facing away from the projecting side (on the side of the optical modulator 25) is formed as a convex spherical surface. The parameters assumed for the lens data in Table 2 given in FIG. 13 include a F value of 2.8, a focal distance of 9.8 mm, an image height of 3.556 mm at the optical modulator 25, a projected object image (Im) height of 365.170 mm at the screen S and a distance of 1,000 mm between the center of the lens surface of the first lens element L1 facing the screen S and the screen S. The image height and the projected object image height are defined in the same way as those of the first embodiment. The weighting of the laser light of various colors are performed in the same manner as in the first embodiment.

The aspheric data of the aspheric lens elements are given in the following similarly as with the first embodiment.
At surface number f2:
   CE4=−7.86074481e-5
   CE6=5.0989131e-6
   CE8=−1.1819951e-8
   CE10 =−3.448836e-9
   CE12=1.8820266e-11
At surface number f3:
   CE4=−0.00047448961
   CE6=6.3768493e-5
   CE8=9.0982912e-9
   CE10=−8.28291e-7
   CE12=3.8041695e-10
At surface number f8:
   CE4=−0.00062894509
   CE6=2.6315444e-5
   CE8=−9.0014583e-7
   CE10=1.5167082e-8
   CE12=−1.2901779e-10
At surface number f9:
   CE4=0.00019208273
   CE6=−5.8501995e-7
   CE8=1.2441806e-7
   CE10=−5.0888151e-9
   CE12=−1.6961643e-11

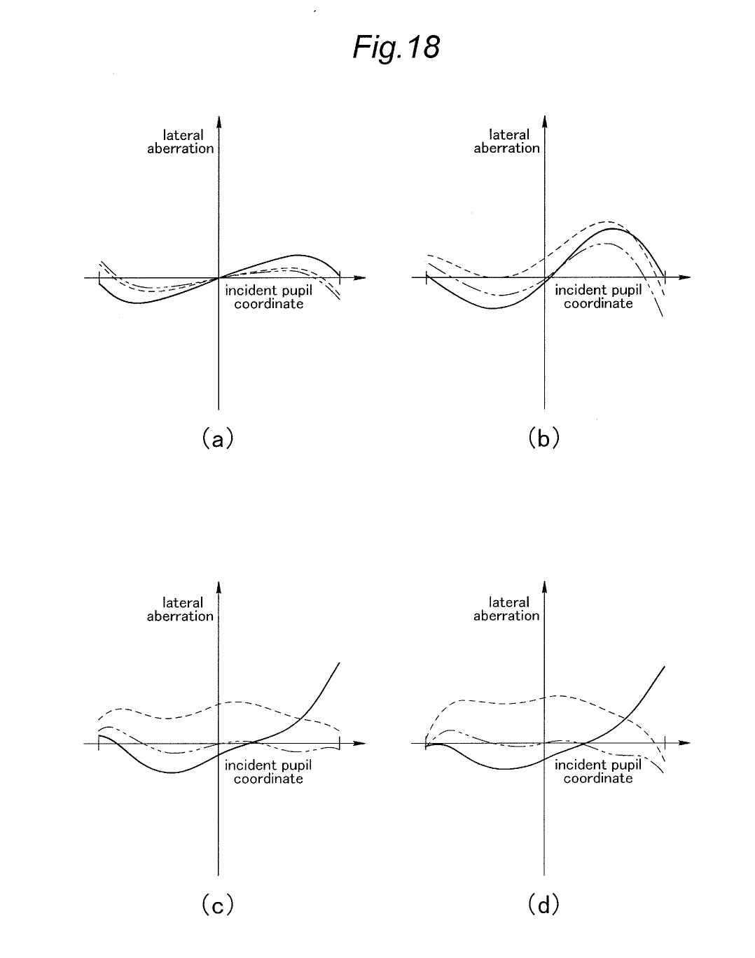

As shown in FIGS. 14 to 18, the various optical aberrations are controlled within acceptable ranges. The image height (P1) in FIG. 18a is 0 mm, the image height (P2) in FIG. 18b is 1.743 mm, the image height (P3) in FIG. 18c is 3.099 mm, and the image height (P4) in FIG. 18d is 3.556 mm.

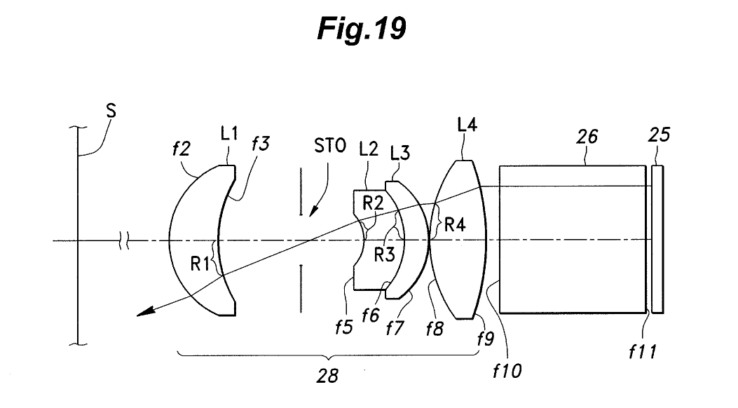

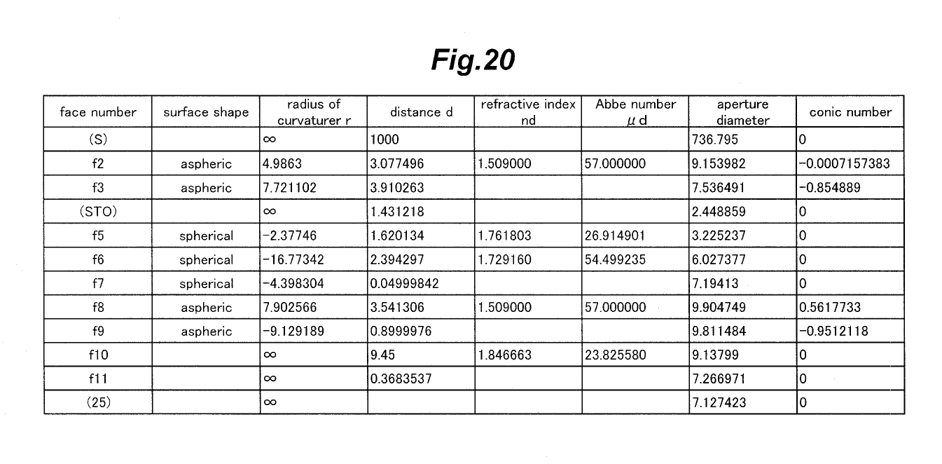

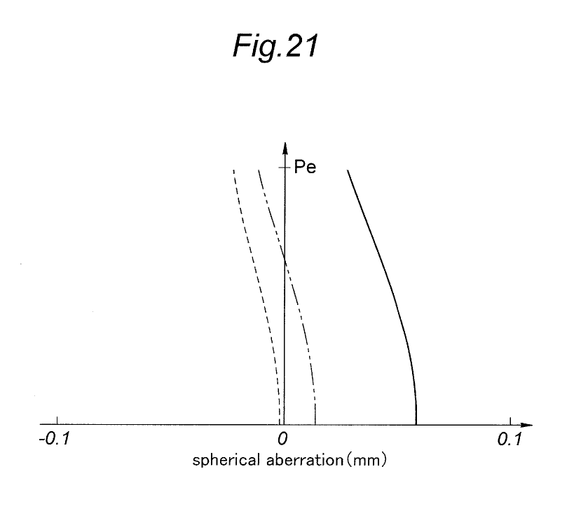

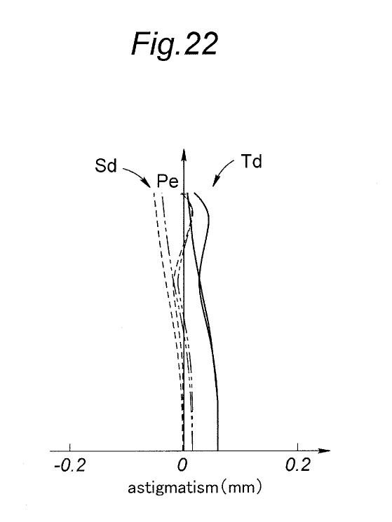

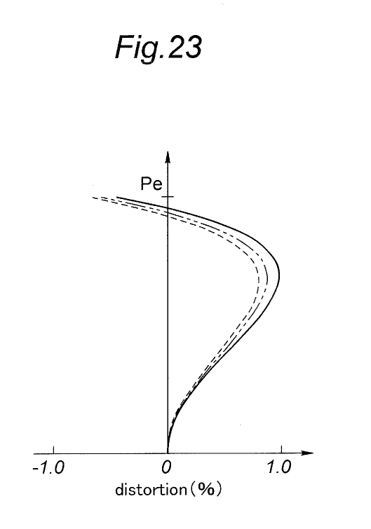

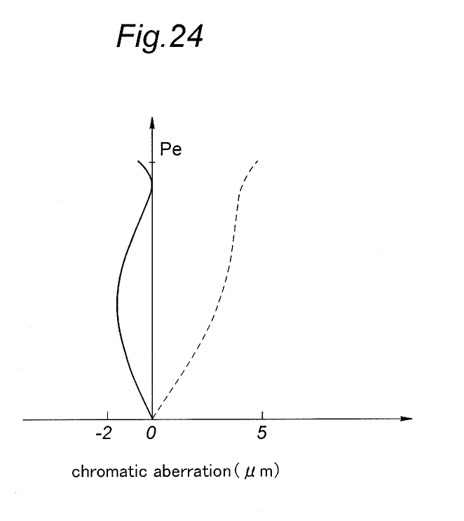

A third embodiment of the present invention is described in the following with reference to FIGS. 19 to 25. FIGS. 19 and 20 correspond to FIGS. 4 and 5, respectively, and FIGS. 21 to 25 correspond to FIGS. 7 to 11. In these drawings, the parts corresponding to those of the first embodiment are denoted with like numerals.

As shown in FIG. 19, in the third embodiment, the lens surface f5 of the second lens element L2 facing the projecting side (on the side facing away from the optical modulator 25) is formed as a concave spherical surface. The parameters assumed for the lens data in Table 3 given in FIG. 20 include a F value of 2.8, a focal distance of 9.8 mm, an image height of 3.564 mm at the optical modulator 25, a projected object image (Im) height of 369.13 mm at the screen S and a distance of 1,000 mm between the center of the lens surface of the first lens element L1 facing the screen S and the screen S. The image height and the projected object image height are defined in the same way as those of the first embodiment. The weighting of the laser light of various colors are performed in the same manner as in the first embodiment.

The aspheric data of the aspheric lens elements are given in the following similarly as with the first embodiment.
At surface number f2:
   CE4=6.843509e-5
   CE6=3.1766495e-6
   CE8=7.2233378e-8
   CE10=−7.3650241e-9
   CE12=5.2732706e-10
At surface number f3:
   CE4 =0.00037286867
   CE6=2.063769e-5
   CE8=−5.3742222e-7
   CE10=1.4666301e-8
   CE12=−7.8445372e-10
At surface number f8:
   CE4=−1.2843437e-5
   CE6=1.8851824e-6
   CE8=6.8991401e-8
   CE10=3.1354425e-9
   CE12=−1.5749645e-10
At surface number f9:
   CE4=0.00089271739
   CE6=−8.5790227e-6l
   CE8=2.2007841e-7
   CE10=1.7873333e-9
   CE12=−2.0959156e-10

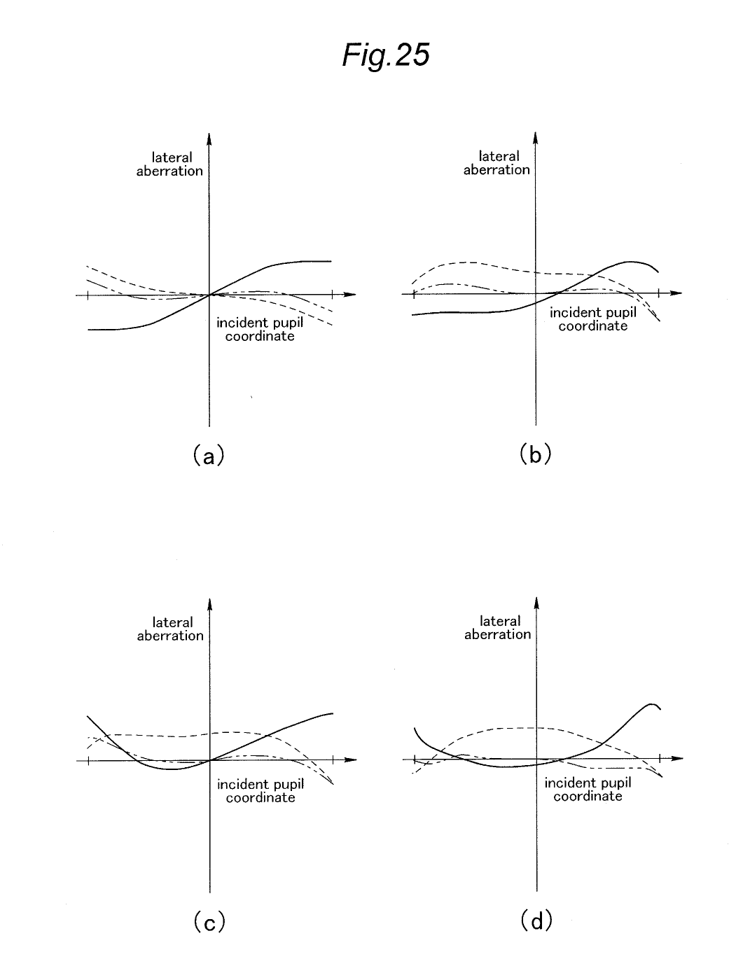

As shown in FIGS. 21 to 25, the various optical aberrations are controlled within acceptable ranges. Similarly as in the second embodiment, the image height (P1) in FIG. 25a is 0 mm, the image height (P2) in FIG. 25b is 1.743 mm, the image height (P3) in FIG. 25c is 3.099 mm, and the image height (P4) in FIG. 25d is 3.556 mm.

The size of the optical modulator 25 in the first embodiment was 0.22inches, but it was increased to 0.28 inches in the third embodiment. Also, the glass material for the polarizing beam splitter 26 was BSC7 (a crown glass designated by the Optical Glass Industry Association of Japan) in the first embodiment, and was changed to SF57HHT (made by Schott AG of Mainz, Germany) in the third embodiment.

Owing to these changes, the MTF (modulation transfer function) which was 831 p/mm (off the axis 40%, on the axis 50%) in the first embodiment is increased to 1,001 p/mm (off the axis 40%, on the axis 50%) in the third embodiment, and it means a significant improved in resolution. As the thickness (on the optical axial line) of the first lens element L1 is reduced from 4.2 mm to 3.1 mm, the cooling time period in the manufacturing process can be significantly reduced, and the manufacturing cost can be thereby reduced. The edge thickness of the fourth lens element L4 is reduced from 0.5 mm to 1 mm, and this simplifies the molding process for the plastic lens. Owing to these factors, the total optical length of the projection lens system 28 which was 30 mm in the first embodiment is reduced to 27 mm in the third embodiment.

The projector lens systems 28 in the foregoing embodiments consisted of four lens elements in each instance, but may also consist of three lens elements without departing from the spirit of the present invention. It is possible to use a single glass lens element, instead of the second and third lens elements L2 and L3 of the foregoing embodiments, so that the projector lens system 28 may be construct by using only three lens elements. Such a modification may slightly may impair the resolution and the brightness as compared with those of the foregoing embodiments, but may be useful when such high grade properties are not required. At any event, the projector lens system 28 according to the present invention can demonstrate a high resolution, a high brightness and a long focal length, and is therefore highly suitable for use in small projectors.

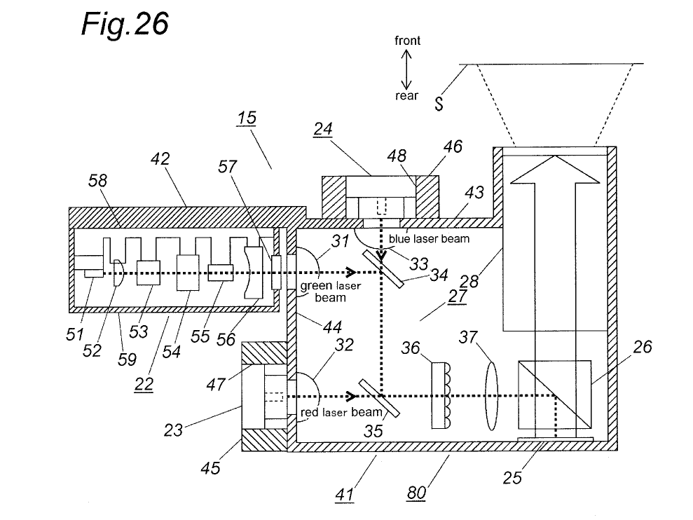

FIG. 26 is a schematic diagram illustrating an optical engine 15 of the optical engine unit 13 of the image display system 1. The optical engine 15 comprises a green laser light source unit 22 for emitting a green laser beam, a red laser light source unit 23 for emitting a red laser beam, a blue laser light source unit 24 for emitting a blue laser beam, a spatial light modulator 25 of a reflective LCD type for forming the required image by spatially modulating the laser beams from the green, red and blue laser light source units 22 to 24 according to the given video signal, a polarizing beam splitter 26 that reflects the laser beams emitted from the green, red and blue laser light source units 22 to 24 onto the spatial light modulator 25 and transmits the modulated laser beam emitted from the spatial light modulator 25, a relay optical system 27 for directing the laser beams emitted from the green, red and blue laser light source units 22 to 24 to the beam splitter 26, and a projector lens system (projection optical system) 28 for projecting the image created by the modulated laser beam and transmitted through the beam splitter 26 onto the screen S. The laser light source units 22 to 24 may use semiconductor lasers as light sources. Thus, an optical system 80 is formed by these optical elements interposed between the laser light source units 22 to 24 and the projector lens system 28.

A part of the lens elements forming the optical system 80 and the projector lens system 28 consist of plastic lenses as will be discussed hereinafter. Those lenses in the optical system 80 and the projector lens system 28 that do not consist of plastic lenses are made of glass.

The optical engine 15 is configured to display a color image on the screen S by using the field sequential process (time sharing display process), and the laser beams of different colors are emitted from the corresponding laser light source units 22 to 24 sequentially in a time sharing manner so that the laser beams of the different colors emitted intermittently and projected onto the screen are perceived as a unified color afterimage.

The relay optical system 27 comprises collimator lenses 31 to 33 for converting the laser beams of different colors emitted from the corresponding laser light source units 22 to 24 into parallel beams of the different colors, first and second dichroic mirrors 34 and 35 for directing laser beams of the different colors exiting the collimator lenses 31 to 33 in a prescribed direction, a diffusion plate 36 consisting of a lenticular lens for diffusing the laser beams guided by the dichroic mirrors 34 and 35 and a field lens 37 for converting the laser beam transmitted through the diffusion plate 36 into a converging laser beam.

If the side of the projector lens system 28 from which the laser beam is emitted to the screen S is defined as the front side, the blue laser light source unit 24 emits the blue laser beam in the rearward direction. The green and red laser light source units 22 and 23 emit the green laser beam and red laser beam, respectively, in a direction perpendicular to the blue laser beam. The blue, red and green laser beams are conducted to a common light path by the two dichroic mirrors 34 and 35. More specifically, the blue laser beam and green laser beam are conducted to a common light path by the first dichroic mirror 3, and the blue laser beam, red laser beam and green laser beam are conducted to a common light path by the second dichroic mirror 3.

The surface of each dichroic mirror 34, 35 is coated with a film that selectively transmits light of a prescribed wavelength while reflecting light of other wavelengths. The first dichroic mirror 34 transmits the blue laser beam while reflecting the green laser beam, and the second dichroic mirror 35 transmits the red laser beam while reflecting the blue and green laser beams.

These optical components are received in a housing 41 which is made of thermally conductive material such as aluminum and copper so as to serve as a heat sink for dissipating the heat generated from the laser light source units 22 to 24.

The green laser light source unit 22 is mounted on a mounting plate 42 secured to the housing 41 and extending laterally from the housing 41. The mounting plate 42 extends from the corner between a front wall 43 and a side wall 44 of the housing 41 in a direction perpendicular to the side wall 44. The red laser light source unit 23 is retained in a holder 45 which is in turn attached to the outer surface of the side wall 44, and the blue laser light source unit 24 is retained in a holder 46 which is in turn attached to the outer surface of the front wall 43.

The red and blue laser light source units 23 and 24 are each prepared in a CAN package in which a laser chip supported by a stem is placed on the central axial line of a can so as to emit a laser beam in alignment with the central axial line of the can and out of a glass window provided on the can. The red and blue laser light source units 23 and 24 are secured to the respective holders 45 and 46 by being press fitted into mounting holes 47 and 48 formed in the corresponding holders 45 and 46. The heat generated in the laser chips of the red and blue laser light source units 23 and 24 is transmitted to the housing 41 via the holders 45 and 46, and is dissipated to the surrounding environment from the housing 41. The holders 45 and 46 may be made of thermally conductive material such as aluminum and copper.

As shown in FIG. 26, the green laser light source unit 22 comprises a semiconductor laser 51 for producing an excitation laser beam, a FAC (fast axis collimator) lens 52 and a rod lens 53 for collimating the excitation laser beam produced from the semiconductor lens 51, a laser mediuim 54 for producing a base wavelength laser beam (infrared laser beam) through excitation by the excitation laser beam, a wavelength converting device 55 for producing a half wavelength laser beam (green laser beam) by converting the wavelength of the base wavelength laser beam, a concave mirror 56 for forming a resonator in cooperation with the laser mediuim 54, a glass cover 57 for preventing the leakage of the excitation laser beam and base wavelength laser beam, a base 58 for supporting the various component parts and a cover member 59 covering the various components.

The base 58 of the green laser light source unit 22 is fixedly attached to the mounting plate 42 of the housing 41 such that a gap of a prescribed width (such as 0.5 mm or less) is formed between the green laser light source unit 22 and the side wall 44 of the housing 41. Thereby, the heat generated from the green laser light source unit 22 is insulated from the red laser light source unit 23 so that the red laser light source unit 23 having a relatively low tolerable temperature is prevented from heat, and is enabled to operate in a stable manner. To obtain a required adjustment margin (such as about 0.3 mm) for the optical center line of the red laser light source unit 23, a certain gap (such as 0.3 mm or more) is provided between the green laser light source unit 22 and the red laser light source unit 23.

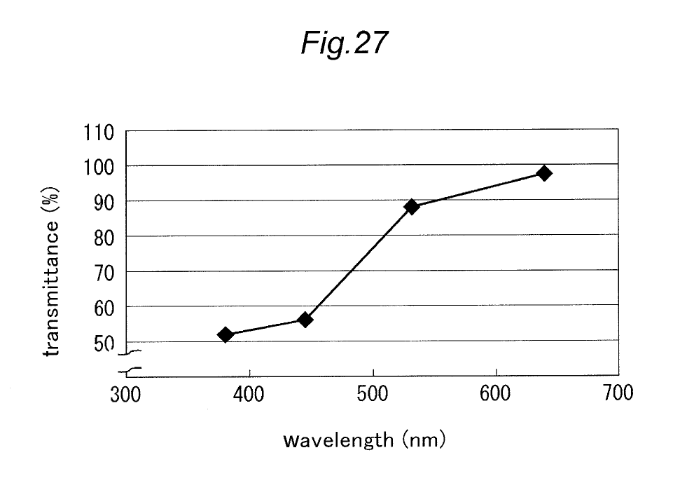

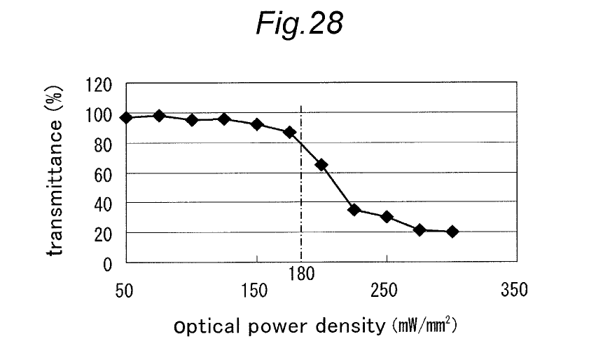

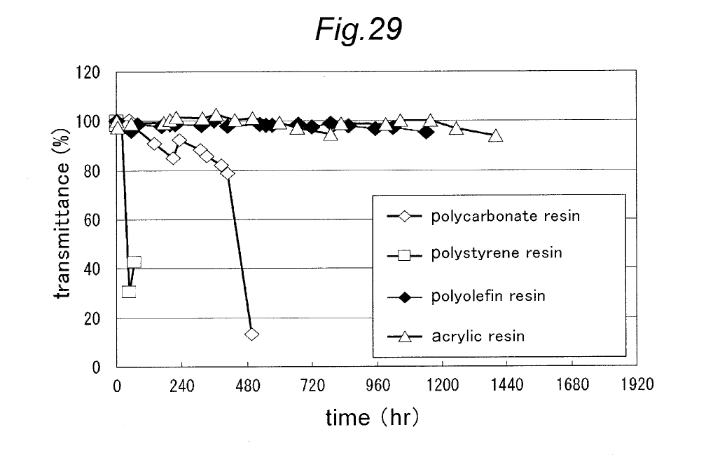

The conditions under which each of the lenses used in the optical system 80 of the optical engine 15 of the image display system 1 may be made of plastic material are discussed in the following with reference to FIGS. 27, 28 and 29. FIG. 27 is a graph showing the changes in the transmittance of the lens when light having various wavelengths is radiated on the lens for 1,000 hours, FIG. 28 is a graph showing the changes in the transmittance of the lens when light of various optical power densities is radiated on the lens, and FIG. 29 is a graph showing the changes in the transmittance of the lens over time when blue light is radiated on the lens in dependence on the materials for the lens.

FIG. 27 compares the transmittance of the material of the lens after light of various wavelengths is radiated thereon for 1,000 hours. As can be seen from this graph, the blue light (having a wavelength of 500 nm or less) causes a greater reduction in the transmittance than the green and red light. In other words, the blue light may impose a restriction on the choice of the material for the lens, but the lenses which transmit only green and red light are more suited to be made of plastic material.

The effect of the optical power density of the blue light which may prevent the use of plastic material for the lens is discussed in the following. FIG. 28 compares the changes in the transmittance of the lens when blue light of various optical power densities is radiated on the lens. As can be seen from this graph, the reduction in the transmittance becomes significant when the optical power density is greater than 180 mW/mm². Therefore, if the power density of the blue light is less than 180 mW/mm², plastic material may be used for the lens in the optical system 80 of the optical engine 15.

Various plastic materials that can be used as the material for the lens were tested. FIG. 29 compares the changes in the transmittance of the lens over time when blue light is radiated on the lens for various materials for the lens. Light having a relatively short wavelength such as blue light is a primary cause for the degradation of the plastic material of the lens as discussed above. The materials that are taken into consideration in view of the ease of the molding process and the mechanical strength include polycarbonate resin, polystyrene resin, polyolefin resin and acrylic resin.

The lateral axis of the graph of FIG. 29 shows the time period of radiating blue laser light having a wave length of 445 nm and an optical power density of 30 mW/mm² upon the lenses made of aforementioned materials, and the vertical axis shows the transmittance of each of the lenses.

As can be seen from the graph of FIG. 29, polystyrene resin is not suitable as the material for the lens because the transmittance thereof sharply drops in a short period of time when exposed to the blue laser light. Polycarbonate resin is also unsuitable as the material for the lens because the transmittance thereof drops significantly in about 400 hours when exposed to the blue laser light.

Polyolefin resin and acrylic resin are suitable for use as the material for lens because the transmittance thereof does not drop significantly even when exposed to blue laser light for more than 1,000 hours. A typical polyolefin resin consists of cyclo-olefin polymer, and a typical acrylic resin consists of methylated poly(methacrylic acid).

The time period of 1,000 hours for radiating the blue laser light was selected on the basis of the typical service period of the optical engine for professional use. It was assumed that a typical service life of an image display system is five years, and the image display system is operated for two hours before noon and afternoon, respectively, five days a week. Further, the lighting duty of the laser light of each color for the field sequential operation is assumed to be 20%. This amounts to the radiation time period of approximately 1,040 hours for the blue laser light. This is a somewhat rigorous condition for evaluation.

As shown in Table A given in the following, the lens elements or lens groups that are subjected to blue laser light of an optical power density of 180 mW/mm² or more include the projector lens system 28, the lenticular lens 36 and the field lens 37 (those given by bolded and italicized figures in Table A.). Therefore, the lenses of these lens elements and lens groups are candidates to be made of plastic material.

TABLE A

| | projector lens | | | |
|---|---|---|---|---|
| Optical | system | Field | lenticular | Collimator |
| F value | (at pupil position) | lens | lens | lens |
| 2.0 | [symbol] | [symbol] | [symbol] | 1,225 |
| 2.8 | [symbol] | [symbol] | [symbol] | 2,400 |
| 4.0 | [symbol] | [symbol] | 242 | 4,899 |
| 5.6 | [symbol] | [symbol] | 409 | 8,278 |

[mW/mm²]

In the following is discussed how the lenses that are to be made of plastic material are selected from those forming the lenses in the optical system 80 and the projector lens system 28.

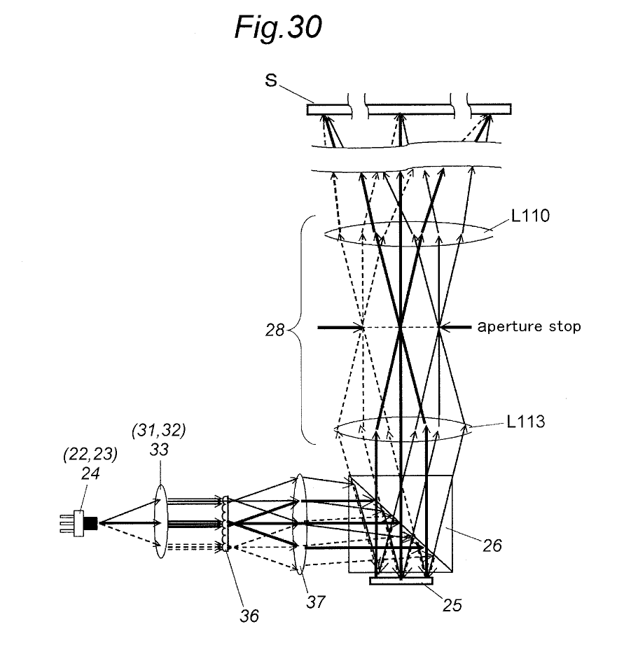

The optical path of the laser beam that passes through the lenses of the optical system 80 of the image display system 1 is described in the following with reference to FIG. 30 which shows the lens layout of the optical system 80 of the image display system.

As shown in FIG. 30, the laser light emitted from the blue laser light source unit 24 passes through the collimator lens 33 to be converted into a parallel beam, and reaches the lenticular lens 36. In other words, the laser light emitted from the blue laser light source unit 24 travels along the optical path indicated by the bold solid line, the solid line and the dotted line. When this laser light reaches the collimator lens 33, the optical power density thereof is at the high level shown in Table A. The optical power density thereof diminishes as the laser light travels through the collimator lens 33 so that the laser light that passes through the lenticular lens 36 has a relatively low optical power density level.

Therefore, the collimator lens 33 is not suited to be made of plastic material as the blue laser light having a high optical density passes through the collimator lens 33. On the other hand, the blue laser light that passes through the lenticular lens 36 is already attenuated to some extent as it has passed through the collimator lens 33 so that the lenticular lens 36 may be made of plastic material as long as the optical power density of the laser light that enters the lenticular lens 36 is below a prescribed threshold (such as 180 mW/mm²).

The blue laser light is dispersed by the lenticular lens 36 before reaching the field lens 37. The optical power density at the field lens 37 is relatively low as shown in Table A owing to the dispersing action of the lenticular lens 36. Therefore, the field lens 37 is suited to be made of plastic material.

While the foregoing discussion was made in conjunction with the blue laser light, the lenses such as the collimator lenses 31 and 32 are also suited to be made of plastic material as they transmit only laser light of green and red colors.

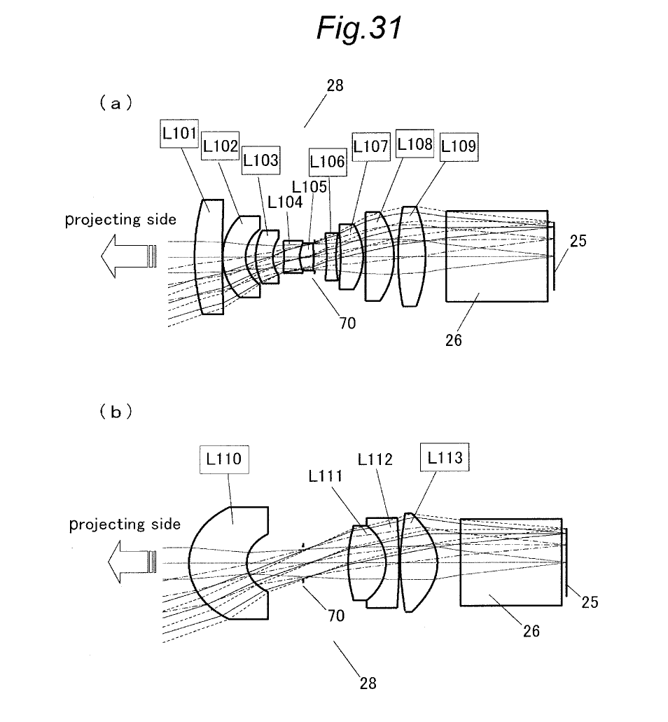

The optical path of the laser beam passing through the lens elements of the projector lens system 28 of the image display system 1 is described in the following with reference to FIG. 31 which shows the possible layouts of the lens elements in the projector lens system 28 of the image display system 1. In particular, FIG. 31a is a schematic diagram of the lens layout of the projector lens system 28 when the lenses are strictly made of glass, and FIG. 31b is a similar view when a part of the lenses are made of plastic material.

As shown in FIG. 31a, the blue laser light emitted from the spatial optical modulator 25 passes through the polarizing beam splitter 26 before reaching the projector lens system 28. At this time, the laser light is shaped into a divergent beam.

More specifically, the blue laser light emitted from the spatial optical modulator 25 travels along the optical path indicated by the solid line, the dotted line and the chain-dot line shown in FIG. 31a. The laser beam is diverged or expanded substantially maximally as it reaches the first lens L109 of the projector lens system 28, and then progressively converges as it travels toward the aperture stop 70. The laser beam that has passed through the aperture stop is then diverged, and projected onto the projecting side.

Therefore, the lenses such as the lenses L101 and L109 (with the reference numerals in a box in FIG. 31a) which are relatively remote from the aperture stop 70 are subjected to a relatively low level of optical power density.

In particular, the laser light such as blue laser light that has a short wavelength has a higher optical energy for the given optical power density causes greater influences (such as reduction in the transmittance) on the plastic material used in the optical system of the image display system 1.

In the illustrated embodiment, those lens elements L101, L102, L103, L106, L107, L108 and L109 that are located in positions where the optical power density of the blue laser light is relatively low are made of plastic material. The lens elements L101, L102 and L103 may be formed as a single lens element consisting of a single aspheric plastic lens L110 as shown in FIG. 31b.

Likewise, the lens elements L106, L107, L108 and L109 may be formed as a single lens element consisting of a single aspheric plastic lens L113 as shown in FIG. 31b.

In this case, it can be seen from the diagram of FIG. 31b that the integrated lens elements L110 and L113 are located at positions where the optical power density of the laser light is relatively low

By forming those lenses of the image display system 1 that are subjected to relatively low levels of the optical power density of the blue laser light as aspheric plastic lenses, the material cost for the lenses is minimized, the fabrication of the lenses is simplified, and the number of necessary lens elements is minimized while the required lens properties for the optical system are maintained. The plastic lenses are easier to be formed as aspheric lenses as compared with glass lenses. Therefore, the use of aspheric lenses allows the required number of lens elements to be minimized, and it contributes to the reduction in the cost of the image display system 1.

Owing to the use of the plastic material for the lenses and the reduction in the number of lens elements, the weight of the image display system 1 can be reduced.

The foregoing discussion was directed to the lenses of the projector lens system 28 which is relatively large in size and great in weight, but the lenses in other parts of the overall optical system of the image display can be made of plastic material based on similar considerations.

In the illustrated embodiments, the lenses of the optical system 80 of the image display system 1 that are subjected to blue laser light having an optical power density of 180 mW/mm² or more are made of glass as corresponding plastic lenses may not have an adequate resistance to optical degradation.

As discussed above, by using plastic aspheric lenses for those lenses in the overall optical system of the image display system 1 that are subjected to light of relatively low optical power densities, the material cost and the manufacturing cost can be both reduced. In particular, the use of plastic material facilitates the fabrication of aspheric lenses, and the use of aspheric lenses allows the minimization of the number of lenses required for the given optical system. This also contributes to the reduction in the cost.

Also, the use of plastic materials and/or the resulting reduction in the number of lenses contribute to the reduction in the weight of the lenses, and this contributes to the reduction in the weight of the image display system 1.

By choosing polyolefin resin and/or acrylic resin as the material for the lenses, the optical degradation of the plastic lenses can be minimized even in the high temperature environment that may exist in compact image display systems.

The light sources for the image display system 1 were lasers in the foregoing embodiments, but may also consist of LEDs. As the laser light is highly coherent, the chromatic aberrations are less significant, as opposed to regular light, so that the design of the optical system is simplified.

As discussed above, according to the present invention, by making some of the lenses in the optical system from plastic lenses, the lens cost can be minimized, and owing to the resulting reduction in the number of lenses in addition to the smaller weight of the material, the weight of the optical system can be reduced. Therefore, the present invention offers a significant contribution in reducing the cost and weight of image display systems.

Although the present invention has been described in terms of preferred embodiments thereof, it is obvious to a person skilled in the art that various alterations and modifications are possible without departing from the scope of the present invention which is set forth in the appended claims. The various components that are used in the image display system are not necessarily indispensable for the present invention, but may be omitted or substituted in implementing the present invention without departing from the spirit of the present invention.

The contents of the original Japanese patent applications on which the Paris Convention priority claim is made for the present application as well as the contents of the prior art references mentioned in this application are incorporated in this application by reference.

1. A projector lens system including at least three lens elements and telecentric on a side of an optical modulator, wherein:
two of the lens elements located on outer most ends of the projector lens system facing conjugate points of the projector lens system consist of plastic lenses;
an aperture stop of the projector lens system is located between the two outer most lens elements; and
at least one of the lens elements other than the two outer most lens elements most adjacent to the aperture stop consists of a glass lens.

2. The projector lens system according to claim 1, wherein at least one of the outer most lens elements is provided with an aspheric face.

3. A projector lens system including a first lens element, a second lens element, a third lens element and a fourth lens element arranged in that order from a projecting side and telecentric on an object side, wherein:
an aperture stop is positioned between the first lens element and the second lens element;
the first lens element consists of a plastic quasi concave meniscus lens having lens surface centrally protruding toward the projecting side and having a negative optical power;
The fourth lens element consists of a plastic quasi biconvex lens having a positive optical power; and
the second lens element and the third lens element consist of glass lenses.

4. The projector lens system according to claim 3, wherein the second lens element and the third lens element jointly form a composite lens having a positive optical power.

5. The projector lens system according to claim 4, wherein the second lens element consists of a biconvex spherical lens or a spherical lens having a concave face facing the first lens component and a convex face facing the third lens element, and the third lens element consists of a biconcave spherical lens or a spherical lens having a concave face facing the second lens element and a convex face facing the fourth lens element.

6. The projector lens system according to claim 3, wherein the second lens element has a greater Abbe number than the third lens element.

7. An image display system, comprising:
a blue light source emitting blue light;
a green light source emitting green light;
a red light source emitting red light; and
an optical system including a plurality of lens elements and receiving the light of the various colors;
wherein at least one of the lens elements that receives the blue light with an optical power density of 180 mW/mm² or less is made of plastic material while at least one of the lens elements that receives the blue light with an optical power density of more than 180 mW/mm² is made of glass.

8. The image display system according to claim 7, further comprising a projector lens system for guiding and projecting the light of the various colors emitted from the light sources of the corresponding colors, wherein the projector lens system comprises at least three lens elements, and at least one of the lens elements on outermost ends along an optical axis is made plastic material.

9. The image display system according to claim 7, wherein the plastic material comprises polyolefin resin or acrylic resin.
